(19) United States
(12) Patent Application Publication
(10) Pub. No.: US 2014/0016216 A1
(43) Pub. Date: Jan. 16, 2014

(54) MANUFACTURING METHOD FOR IMAGE PICKUP LENS UNIT AND IMAGE PICKUP LENS

(71) Applicants: Hajime Mori, Fuchu-shi (JP); Dai Akutsu, Nerima-ku (JP); Takemi Miyazaki, Hamura-shi (JP)

(72) Inventors: Hajime Mori, Fuchu-shi (JP); Dai Akutsu, Nerima-ku (JP); Takemi Miyazaki, Hamura-shi (JP)

(21) Appl. No.: 14/007,879

(22) PCT Filed: Mar. 27, 2012
(86) PCT No.: PCT/JP2012/057997

§ 371 Date: Sep. 26, 2013

(51) Int. Cl. G02B 7/02; B29D 11/00

(52) U.S. Cl. CPC G02B 7/02; B29D 11/0074
USPC 359/811; 264/1.7

(57) ABSTRACT

The present invention provides a manufacturing method for an image pickup lens unit, with which deformation of a lens occurring during molding of a holder can be suppressed. A resin holder member 40 that holds a lens 10 in position in an interior thereof can be formed. At this time, surfaces of first and second lens layers 12 and 13 of the lens 10 may be deformed by molds 51 and 52 such that a depression 12r or the like remains in the first and second lens layers 12 and 13. By subjecting the lens 10 and the holder member 40 to heating treatment, however, this distortion can be released, and as a result, an original optical precision of the first and second optical surfaces 12d and 13e of the lens 10 can be restored.

### TECHNICAL FIELD

The present invention relates to a method for manufacturing an image pickup lens unit in which a lens is incorporated into a holder, and to an image pickup lens unit.

### BACKGROUND ART

An image pickup lens unit incorporated into a portable telephone or the like is structured such that a periphery of an image forming optical lens is held by a holder. Positioning precision when incorporating the optical lens into the holder is extremely strict, and therefore the optical lens is normally incorporated into the holder using an automatic assembly system employing image recognition technology. However, this system is extremely expensive, and moreover, an extremely large site is required to construct a manufacturing line on which a process for inserting the lens into the holder, a process for adhering the lens to the holder, and so on are performed separately. Furthermore, extremely extensive work is required to replace facilities whenever the lens type is modified, necessitating a large number of man-hours.

As a manufacturing method for solving these problems, a technique of assembling an image pickup lens unit in a single process by setting and positioning an optical glass lens and a diaphragm in a mold in advance and then forming a holder by performing injection molding on the periphery of the optical glass lens and so on is known (see Patent Document 1).

In the manufacturing method of Patent Document 1, to ensure that resin does not flow into a part corresponding to an opening of the holder, a resin restricting member that contacts a peripheral portion of an optical surface exposed through the opening must be provided in the mold for molding. When a pressing force of the resin restricting member is insufficient, resin flows onto the optical surface, and therefore the resin restricting member must be brought into contact with the lens by a pressing force of at least a predetermined magnitude. Needless to mention, when the pressing force of the resin restricting member is too large, the optical glass lens deforms or breaks, and therefore the pressing force of the resin restricting member must be adjusted appropriately. It has been found, however, that in a case where a plastic lens is held in the holder instead of an optical glass lens, slight stress applied by the resin restricting member causes a contact part of the plastic lens to deform into an indentation even when the pressing force of the resin restricting member is appropriate, and this deformation affects the optical surface. Particularly in a case where the holder is molded using resin that is melted by heat, the plastic lens is softened by the heat generated during molding of the holder such that the problem described above occurs even more strikingly. It has also been found that this problem occurs likewise when the plastic lens is constituted by an energy hardening resin such as photo-curable resin or thermosetting resin.

### CITATION LIST

### Patent Literature

Patent Document 1: Japanese Patent Application Publication No. 2009-300626

### SUMMARY OF INVENTION

The present invention has been designed in consideration of these problems in the background art, and an object thereof is to provide a manufacturing method for an image pickup lens unit in which a holder is molded together with a lens, with which deformation of the lens occurring during molding of the holder can be suppressed.

Another object of the present invention is to provide an image pickup lens unit in which deformation of a lens occurring during molding of a holder is suppressed.

A manufacturing method for an image pickup lens unit according to the present invention includes the steps of: forming a holder member that holds a lens at least partially including resin, integrally in an interior thereof by disposing the lens in position in a mold having a molding space for molding at least a part of the holder member, and then charging resin into the molding space and hardening the resin; and releasing distortion occurring in the lens during formation of the holder member by implementing heating treatment on the lens held by the holder member.

According to the manufacturing method described above, the resin holder member can be formed such that the lens is held in position in the interior thereof. At this time, a surface of the lens may be deformed by the mold such that distortion affecting an optical surface of the lens remains in the lens. By implementing the lens and the holder member to the heating treatment, however, this distortion can be released, and as a result, an original optical precision of the optical surface of the lens can be restored. In other words, the lens can be returned to its original condition after deforming during molding of the holder member, and therefore an image pickup lens unit in which deformation of the lens occurring during molding of the holder member is suppressed can be provided.

According to a specific aspect of the present invention, in the manufacturing method described above, the lens is a compound lens including a substrate and a lens layer, and the lens layer is made of resin. In this case, the lens layer deforms during molding of the holder member, but by implementing the heating treatment on the lens and the holder member, the lens layer can be substantially restored to its original, pre-deformation condition.

According to another aspect of the present invention, the lens is a combination lens including a plurality of integrated lens elements, and at least one of the plurality of lens elements is made of resin. In this case, at least one of the lens elements deforms during molding of the holder member, but by implementing the heating treatment on the lens and the holder member, the lens element can be substantially restored to its original, pre-deformation condition.

According to a further aspect of the present invention, the lens is formed using an energy hardening resin. In this case, the deformation of the lens caused by the mold is embedded in the energy hardening resin constituting the lens as distortion during molding of the holder member, but the distortion can be released by implementing the heating treatment.

According to a further aspect of the present invention, the lens is formed using a thermoplastic resin. In this case, the deformation of the lens caused by the mold is embedded in the thermoplastic resin constituting the lens as distortion during molding of the holder member, but the distortion can be released by implementing the heating treatment.

According to a further aspect of the present invention, the holder member is formed from at least one of LCP (Liquid Crystal Polymer) resin and PPA (Polyphthalamide) resin. In this case, the image pickup lens unit can be processed in a reflow process easily.

According to a further aspect of the present invention, the mold includes at least one contact member that prevents the resin from flowing onto at least one optical surface provided in a surface of the lens. In this case, distortion may remain in the optical surface of the lens due to the contact member, but by implementing the heating treatment on the lens and the holder member, the optical surface of the lens can be substantially returned to its original condition.

According to a further aspect of the present invention, the at least one contact member contacts an outer side of the optical surface while avoiding the optical surface. In this case, the outer side of the optical surface may deform, and this deformation may lead to distortion of the optical surface of the lens. However, the generated distortion can be released by implementing the heating treatment.

According to a further aspect of the present invention, the at least one contact member has a substantially identical shape to the optical surface and contacts the optical surface. In this case, distortion may be generated directly on the optical surface of the lens by the contact member.

According to a further aspect of the present invention, the heating treatment is performed in a temperature range equal to or higher than a lower limit temperature that is 20° C. lower than a deflection temperature under load (ISO75 A method) of a resin part of the lens and lower than an upper limit temperature corresponding to a decomposition temperature or a melting point of the resin part of the lens. In this case, the lens can be softened to a sufficient degree to release the distortion, and damage to the lens due to excessive softening can be prevented.

According to a further aspect of the present invention, the heating treatment is performed in a temperature range equal to or lower than 260° C., which is an upper limit of a use environment temperature of the lens. In this case, damage to the lens can be prevented reliably.

According to a further aspect of the present invention, a deflection temperature under load of the holder member is higher than a deflection temperature under load of a resin part of the lens. In this case, the distortion of the lens can be released while preventing the holder member from deforming.

According to a further aspect of the present invention, the holder member is formed by disposing a resin body constituting a part of the holder in the mold before disposing the lens in the mold, charging the resin into the mold, and hardening the resin such that the hardened resin is joined to the resin body. By disposing the resin body constituting a part of the holder in the mold before disposing the lens in the mold, the part of the holder to be molded after disposing the lens in the mold can be reduced, enabling a reduction in the distortion of the lens.

An image pickup lens unit according to the present invention includes: a lens having a first optical surface and a second optical surface; and a holder member that is formed by supplying resin to a periphery of the lens while the lens is disposed in a mold and then hardening or curing the resin such that the lens is held integrally in an interior of the holder member, wherein the lens is subjected to heating treatment while being held by the holder member.

In the image pickup lens unit described above, a surface of the lens may be deformed by the mold while forming the holder member that holds the lens integrally in the interior thereof, and as a result, distortion that affects the optical surface of the lens may remain in the lens. By implementing the heating treatment on the lens while the lens is held by the holder member, however, an optical precision of the optical surface of the lens can be restored or substantially restored, and therefore an image pickup lens unit in which deformation of the lens occurring during molding of the holder member is suppressed can be provided.

According to a specific aspect of the present invention, in the image pickup lens unit described above, the lens includes a contact impression formed by a contact member that is provided in the mold to prevent the resin from flowing onto at least one of the first optical surface and the second optical surface. In this case, the contact impression is returned to a substantially flat condition by the heating treatment, and as a result, the optical precision of the optical surface of the lens can be restored.

### BRIEF DESCRIPTION OF DRAWINGS

FIG. 1A is a side sectional view showing a structure of an image pickup lens unit according to a first embodiment, and FIG. 1B is a perspective view of the image pickup lens unit;

FIGS. 2A and 2B are partially enlarged sectional views illustrating deterioration of an optical surface of a lens occurring during molding of a holder member, and FIG. 2C is a partially enlarged sectional view illustrating repair of the optical surface and so on;

FIG. 3A is a view illustrating an initial shape precision of the lens, FIG. 3B is a view illustrating the shape precision of the lens following incorporation into the holder member, and FIG. 3C is a view illustrating the shape precision of the lens following heating treatment;

FIG. 4 is a flowchart illustrating procedures for manufacturing the image pickup lens unit shown in FIG. 1;

FIGS. 5A to 5D are views illustrating a lens manufacturing process;

FIG. 6 is a view illustrating apart of a manufacturing process of the image pickup lens unit;

FIG. 7A is a sectional view illustrating formation of a cavity by a manufacturing apparatus, and FIG. 7B is a sectional view illustrating molding of the holder member;

FIG. 8A is a sectional view illustrating opening of molds of the manufacturing apparatus, and FIG. 8B is a sectional view illustrating extraction of the image pickup lens unit;

FIG. 9 is a view illustrating a thermostat bath used during heat treatment;

FIG. 10 is a sectional view illustrating an image pickup lens unit according to a second embodiment;

FIGS. 11A and 11B are sectional views illustrating an image pickup lens unit and a manufacturing method thereof according to a third embodiment; and

FIGS. 12A and 12B are sectional views illustrating an image pickup lens unit and a manufacturing method thereof according to a fourth embodiment.

### DESCRIPTION OF EMBODIMENTS

### First Embodiment

A structure of an image pickup lens unit and a manufacturing method thereof according to a first embodiment of the present invention will be described below with reference to the drawings.

### (A. Structure of Image Pickup Lens Unit)

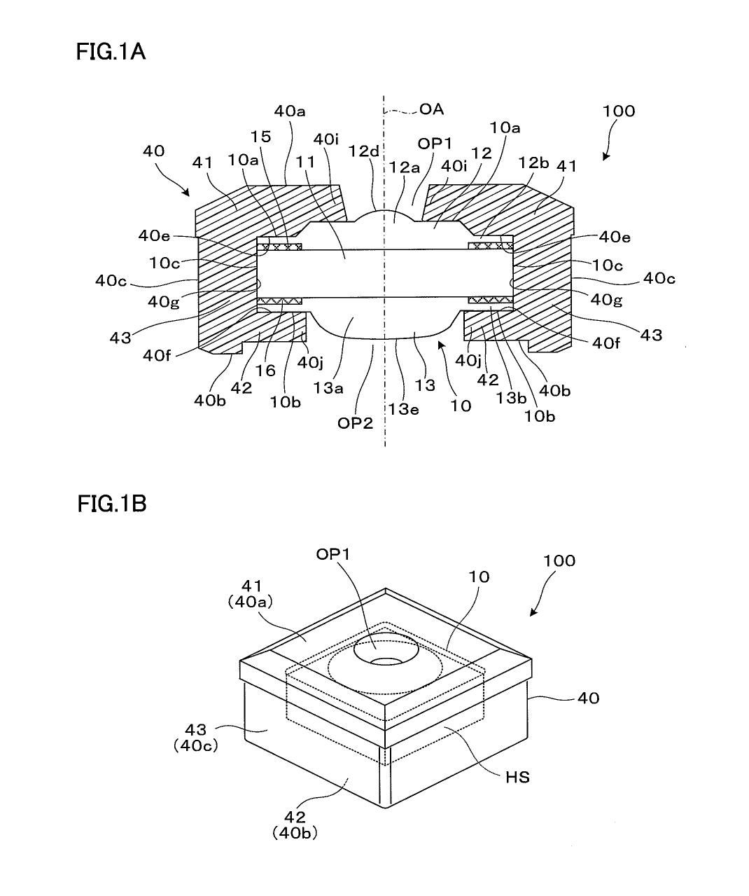

As shown in FIGS. 1A and 1B, an image pickup lens unit 100 includes a lens 10 serving as an optical function portion housed in an interior thereof, and a case-shaped holder member 40 that holds the lens 10 from a periphery thereof.

Here, the lens 10 is cut out from a lens wafer (a wafer-shaped base material) on which a large number of lenses are arranged by dicing, for example. When seen from above, the lens 10 has a rectangular outline with a quadratic prism-shaped side face. The lens 10 is a compound lens constructed by sandwiching a glass substrate 11 between a first lens layer 12 and a second lens layer 13 made of resin.

The glass substrate 11 is a flat plate having a light transmitting property. The glass substrate 11 is not limited to glass, and may be replaced by a substrate formed from a resin material or the like. The glass substrate 11 may also have an additional function as an IR cut filter (an infrared cut filter) or the like.

The first lens layer 12 includes a lens main body portion 12a that has a circular outline and is provided in a central portion on a periphery of an optical axis OA, and a frame portion 12b that has a rectangular outline and extends from a periphery of the lens main body portion 12a. The lens main body portion 12a is an aspheric lens portion, for example, in which a first optical surface 12d is provided on an exposed front side. The first optical surface 12d and a first frame surface 10a on an outer side thereof form a first surface of the lens 10. The first lens layer 12 is formed from a hardening resin possessing reflow heat resistance, for example. Thermosetting resin, photo-curable resin, radiation curable resin, and so on may be cited as examples of hardening resin.

Similarly, the second lens layer 13 includes a lens main body portion 13a that has a circular outline and is provided in a central portion on the periphery of the optical axis OA, and a frame portion 13b that has a rectangular outline and extends from a periphery of the lens main body portion 13a. The lens main body portion 13a is an aspheric lens portion, for example, in which a second optical surface 13e is provided on an exposed front side. The second optical surface 13e and a second frame surface 10b on an outer side thereof form a second surface of the lens 10. The second lens layer 13 is formed from a hardening resin possessing reflow heat resistance, for example.

Note that the first lens layer 12 and the second lens layer 13 may be formed from a thermoplastic resin instead of a hardening resin. However, the first lens layer 12 and the second lens layer 13 must maintain thermal stability during molding of the holder member 40, to be described below, and therefore, in this case, the first lens layer 12 and the second lens layer 13 preferably possess a heat characteristic whereby they are unlikely to be softened by heat generated during molding of the holder.

In the lens 10 described above, a first diaphragm 15 is provided between the glass substrate 11 and the first lens layer 12. Further, a second diaphragm 16 is provided between the glass substrate 11 and the second lens layer 13. The diaphragms 15 and 16 are bracelet-shaped members respectively having openings shaped to follow edges of respective openings OP1 and OP2 of the holder member 40 without interfering with the second optical surface 13e and the like on the second lens layer 13 side. The diaphragms 15 and 16 are formed from metal film or light blocking resin film, for example. Black paint or black photoresist may be used as the light blocking resin film.

The holder member 40 housing the lens 10 is made of resin that is sufficiently heat resistant to withstand at least heating treatment to be described below. The holder member 40 is preferably formed from a thermoplastic resin (LCP, PPA, or the like, for example) possessing reflow heat resistance, for example. The holder member 40 includes an upper portion 41 having a rectangular plate-shaped outline, a bottom portion 42 having a rectangular plate-shaped outline, and a side wall portion 43 having a rectangular tube-shaped outline. A rectangular prism-shaped housing space HS in which the lens 10 is fitted and held is formed in an interior of the holder member 40. As will be described in detail below, the holder member 40 is molded integrally by subjecting the resin to injection molding, and is thus formed as a single integral member. Note that by forming the lens 10 and the holder member 40 from materials possessing reflow heat resistance, the heat resistant image pickup lens unit 100 can be processed in a reflow process.

The upper portion 41 of the holder member 40 opposes the first frame surface 10a on an upper side of the lens 10 held in the housing space HS so as to limit upward movement of the lens 10 along the optical axis OA. The bottom portion 42 opposes the second frame surface 10b on a lower side of the lens 10 so as to limit downward movement of the lens 10 along the optical axis OA. The side wall portion 43 opposes four side faces 10c of the lens 10 so as to limit movement of the lens 10 in a lateral direction perpendicular to the optical axis OA. Hence, the upper portion 41, bottom portion 42, and side wall portion 43 of the single holder member 40 are in close contact with the lens 10, and are therefore capable of preventing the lens 10 from moving relative to the holder member 40 reliably.

The circular opening OP1 is formed in a center of the upper portion 41. A ring-shaped edge portion 40i surrounding the opening OP1 is disposed to shield a periphery of the first optical surface 12d of the lens 10, and therefore functions as a type of diaphragm. Further, the circular opening OP2 is formed in a center of the bottom portion 42. A ring-shaped edge portion 40j surrounding the opening OP2 is disposed to shield a periphery of the second optical surface 13e of the lens 10, and therefore functions as a type of diaphragm.

The surface of the lens 10, excluding the first and second optical surfaces 12d and 13e that are ultimately exposed and a region in the vicinity of the first and second optical surfaces 12d and 13e that is contacted by a mold during molding of the holder member 40, comes into contact with unhardened fluid resin during injection molding of the holder member 40. When the resin hardens, therefore, an inner surface 40e of the upper portion 41 of the holder member 40 is adhered to the first frame surface 10a of the lens 10, for example. Further, an inner surface 40f of the bottom portion 42 is adhered to the second frame surface 10b of the lens 10. More particularly, since the surface of the lens 10 is made of resin, a surface of the first frame surface 10a of the lens 10 is softened by heat generated during injection molding of the holder member 40, and as a result, the first frame surface 10a of the lens 10 and the inner surface 40e of the upper portion 41 of the holder member 40, for example, are welded to each other so as to be joined securely and directly without the use of an adhesive. Similarly, the second frame surface 10b of the lens 10 and the inner surface 40f of the bottom portion 42 of the holder member 40, and also the side faces 10c of the lens 10 and an inner surface 40g of the side wall portion 43 of the holder member 40, are joined directly without the use of an adhesive.

In the image pickup lens unit 100 having the configuration described above, the holder member 40 comes into intimate contact with the periphery of the lens 10 closely without gaps, and therefore ghosting and flaring occurring when light enters through a lens side face can be prevented. Furthermore, no unnecessary gaps are formed in the side faces 10c of the lens 10, and therefore the image pickup lens unit 100 can be reduced in size so as to be more likely to satisfy external appearance specifications required when the image pickup lens unit 100 is mounted in a final product such as an image pickup apparatus. Hence, a reduction in a dimensional precision of the holder member 40 caused by deformation occurring upon release thereof from the mold can be suppressed in comparison with a conventional holder.

Note that the lens 10 is described above as a compound lens, but the lens 10 may be formed entirely from a single resin material.

### (B. Deterioration and Restoration of Optical Surface of Lens)

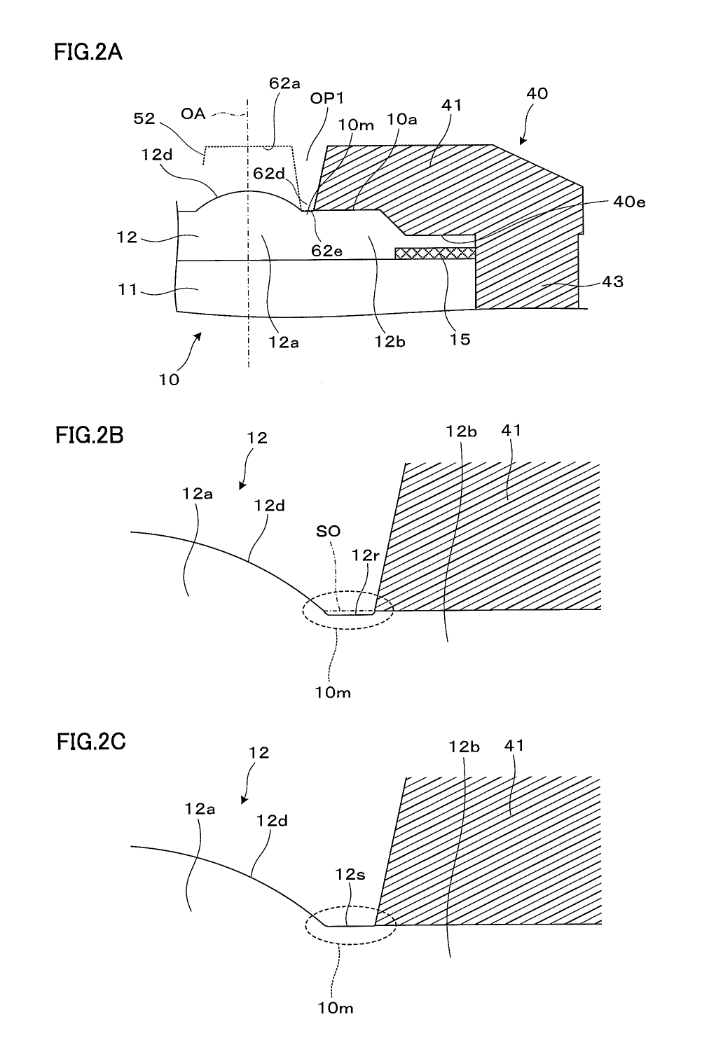

Referring to FIGS. 2A and 2B, deterioration of the first optical surface 12d of the lens 10 will be described. As noted above, the holder member 40 is molded integrally by subjecting resin to injection molding, and therefore, during the molding, an end surface 62e on a tip end of a fixing member 62d that extends from a mold 52 for molding contacts a narrow ring-shaped boundary portion 10m between the first optical surface 12d and the first frame surface 10a of the lens 10. The fixing member 62d is essential for preventing fluid resin from flowing to the first optical surface 12d side, but in order to prevent resin leakage, the fixing member 62d must be pressed against the boundary portion 10m by at least a predetermined pressure. Moreover, during molding of the holder, the heat of the resin affects the boundary portion 10m, and as a result, a shallow depression 12r is formed in the boundary portion 10m in the form of an indentation, as shown in FIG. 2B. The depression 12r is between several μm and several tens of μm lower than an original surface level SO, and therefore forms a step relative to a periphery thereof. The depression 12r itself is formed on an outer side of the first optical surface 12d and does not therefore directly affect the performance of the lens 10. However, the present inventor discovered during an investigation that formation of the depression 12r affects a shape precision, or in other words an optical precision, of the first optical surface 12d. More specifically, the present inventor found that when the lens 10 is inserted into the holder member 40, the shape precision of the first optical surface 12d deteriorates, and as the depression 12r deepens, the shape precision of the first optical surface 12d adjacent thereto deteriorates further. Deterioration of the shape precision of the first optical surface 12d may be permitted depending on the specifications of the image pickup lens unit 100, but considering that a level of optical specifications required of an image pickup lens unit 100 is gradually increasing, deformation of the shape of the first optical surface 12d is preferably minimized. Note that the depth of the depression 12r can be reduced to a certain extent by reducing a resin temperature and a mold temperature, but in so doing, a different problem arises in that a fluidity of the resin during the injection molding decreases, causing defects in the outer appearance of the holder member 40 and so on. It is therefore difficult to prevent deterioration of the shape precision of the optical surface by reducing the resin temperature and the mold temperature.

A possible reason why the shape precision of the first optical surface 12d deteriorates as the depression 12r deepens is that the heated first lens layer 12 is elastically deformed in the boundary portion 10m by a pressing force applied by the end surface 62e of the fixing member 62d of the mold 52 for injection molding, and this deformation is spread by stress on the periphery of the boundary portion 10m, with the result that the entire first optical surface 12d of the lens main body portion 12a deforms. The deformation remains in the form of the depression 12r in the boundary portion 10m and slight shape variation in the first optical surface 12d even after a molded product is extracted from the mold as the image pickup lens unit 100 following molding of the holder. More specifically, during injection molding of the holder member 40, the first lens layer 12 is temporarily exposed to a high temperature and then gradually cooled, but even after the cooled molded product is extracted from the mold 52, the depression 12r corresponding to the tip end shape of the fixing member 62d remains, and this shape variation in the depression 12r spreads so as to remain as slight shape variation in the first optical surface 12d.

The slight shape variation in the first optical surface 12d remains as a history of deformation caused by stress from the mold 52. It is therefore believed that by applying heat to the image pickup lens unit 100 obtained by molding the holder, the depression 12r formed in the boundary portion 10m can be restored to a flat impression 12s close to the original, as shown in FIG. 2C, with the result that the slight shape variation in the first optical surface 12d is eliminated so as to restore the original shape precision of the first optical surface 12d. In this embodiment, distortion in the boundary portion 10m of the first lens layer 12 and the periphery thereof is released by heating the image pickup lens unit 100, which is obtained after forming the holder member 40 by performing injection molding on the periphery of the lens 10, for at least a predetermined time.

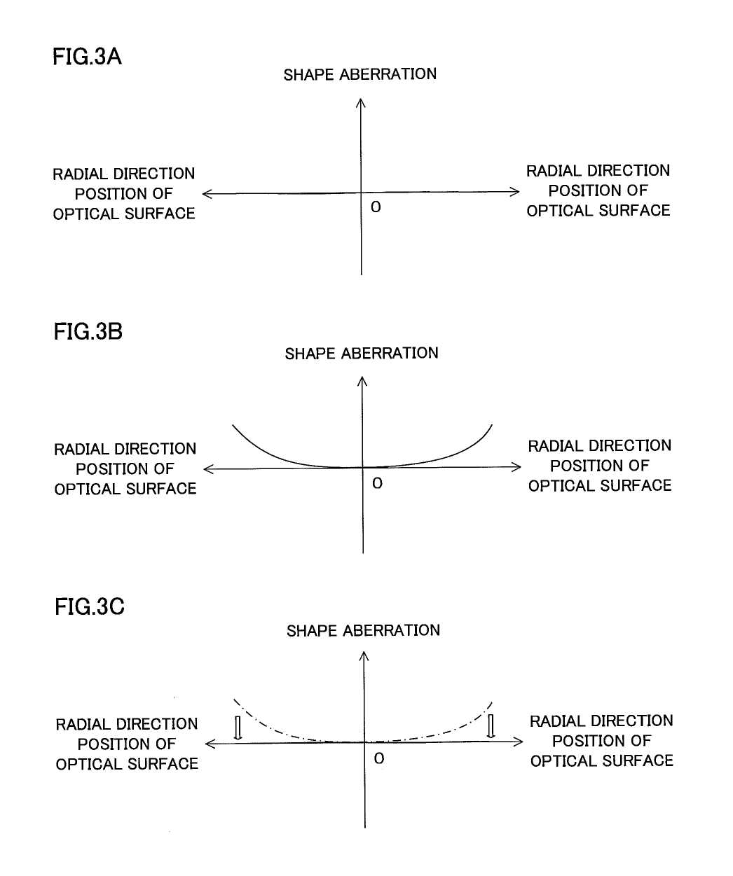

FIG. 3A shows a condition of the first optical surface 12d of the lens 10 prior to molding of the holder member 40. In FIG. 3A, the ordinate shows shape aberration in the first optical surface 12d, and the abscissa shows a distance of the first optical surface 12d from the optical axis OA or a position thereof. As is evident from the drawing, the first optical surface 12d exhibits substantially no aberration. FIG. 3B shows a condition of the first optical surface 12d of the lens 10 immediately after molding of the holder member 40. As is evident from the drawing, the first optical surface 12d exhibits aberration that increases particularly rapidly on a peripheral portion thereof. FIG. 3C shows a condition of the first optical surface 12d of the lens 10 after heating treatment has been implemented on the image pickup lens unit 100 for at least the predetermined time. As is evident from the drawing, the first optical surface 12d again exhibits substantially no aberration. The condition prior to implementation of the heating treatment is indicated by a dot-dash line for reference.

When the image pickup lens unit 100 was actually manufactured and observed under a microscope, the depression 12r was formed comparatively obviously in the boundary portion 10m prior to the heating treatment, as shown in FIG. 2B, but after the heating treatment, as shown in FIG. 2C, the substantially flat impression 12s close to the original shape was formed in the position of the boundary portion 10m.

Deterioration and restoration of the first optical surface 12d of the lens 10 was described above, but the second optical surface 13e is deformed in a similar manner during injection molding of the holder member 40. Hence, the deformation of the second optical surface 13e can also be substantially eliminated by the heating treatment described above, thereby restoring the shape precision of the second optical surface 13e. In other words, by subjecting the image pickup lens unit 100 to the heating treatment following injection molding of the holder member 40, the optical performance of the lens 10 can be substantially returned to its original condition.

The heating treatment for releasing the distortion of the lens 10 is performed in consideration of thermal characteristics of the first lens layer 12 and second lens layer 13 constituting the lens 10. More specifically, the heating treatment is performed in a temperature range equal to or higher than a lower limit temperature that is 20° C. lower than a deflection temperature under load of the resin material constituting the first and second lens layers 12 and 13 and lower than an upper limit temperature corresponding to a decomposition temperature or a melting point of the resin part of the first and second lens layers 12 and 13. Here, the deflection temperature under load is given by the ISO75 A method. Note that when the first and second lens layers 12 and 13 are formed from different resin materials, a value 20° C. lower than the higher deflection temperature under load is set as the lower limit temperature, and the lower decomposition temperature or melting point is set as the upper limit temperature. By setting the temperature of the heating treatment at or above the lower limit temperature that is 20° C. lower than the deflection temperature under load of the resin material constituting the first and second lens layers 12 and 13, the lens 10 can be softened to a sufficient degree to release the distortion therein. Further, by setting the upper limit temperature at the decomposition temperature or the melting point (normally, the lower temperature of the decomposition temperature and the melting point), i.e. a heatproof temperature, of the resin part of the lens and setting the temperature of the heating treatment to be lower than the upper limit temperature, damage to the lens 10 caused by excessive softening can be prevented.

The heating treatment for releasing distortion of the lens 10 is preferably performed in a temperature range of no higher than 260° C., which is an upper limit of a use environment temperature of the lens 10. According to the specifications of the lens 10 incorporated into the image pickup lens unit 100, the upper limit of the use environment temperature thereof is 260° C., and by performing the heating treatment in a temperature range of no higher than the upper limit of 260° C., deterioration of the performance of the lens 10 can be prevented more reliably. Furthermore, to release the distortion of the lens 10 even more easily and sufficiently, the heating treatment is preferably performed at or above the deflection temperature under load of the lens resin.

The heating treatment for releasing distortion of the lens 10 must also be performed in consideration of the thermal characteristics of the holder member 40. More specifically, the heating treatment is performed at a lower temperature than the heatproof temperature (the decomposition temperature or the melting point, normally the lower temperature of the decomposition temperature and the melting point) of the resin constituting the holder member 40. Moreover, in consideration of a dimensional precision of the holder, a resin having a higher deflection temperature under load than the resin of the first and second lens layers 12 and 13 of the lens 10 is preferably used as the resin constituting the holder member 40. As the deflection temperature under load of the holder member 40 increases above that of the first and second lens layers 12 and 13, a dimensional stability of the holder member during the heating treatment increases, and setting limitations on the heating treatment temperature are reduced. More preferably, the former is at least 50° C. higher than the latter. When the deflection temperature under load of the resin constituting the holder member 40 is higher than the deflection temperature under load of the resin constituting the first and second lens layers 12 and 13 of the lens 10, the lower limit temperature of the heating treatment need only be set in consideration of the deflection temperature under load of the first and second lens layers 12 and 13.

By performing the heating treatment described above, distortion of the lens 10 is released. It is therefore possible to determine accurately whether or not a desired optical performance has been obtained by inspecting the image pickup lens unit. An imaging device is then mounted in the image pickup lens unit satisfying the prescribed optical performance by performing reflow processing, and as a result, an image pickup unit exhibiting a favorable performance can be obtained.

### (C. Manufacturing Process of Image Pickup Lens Unit)

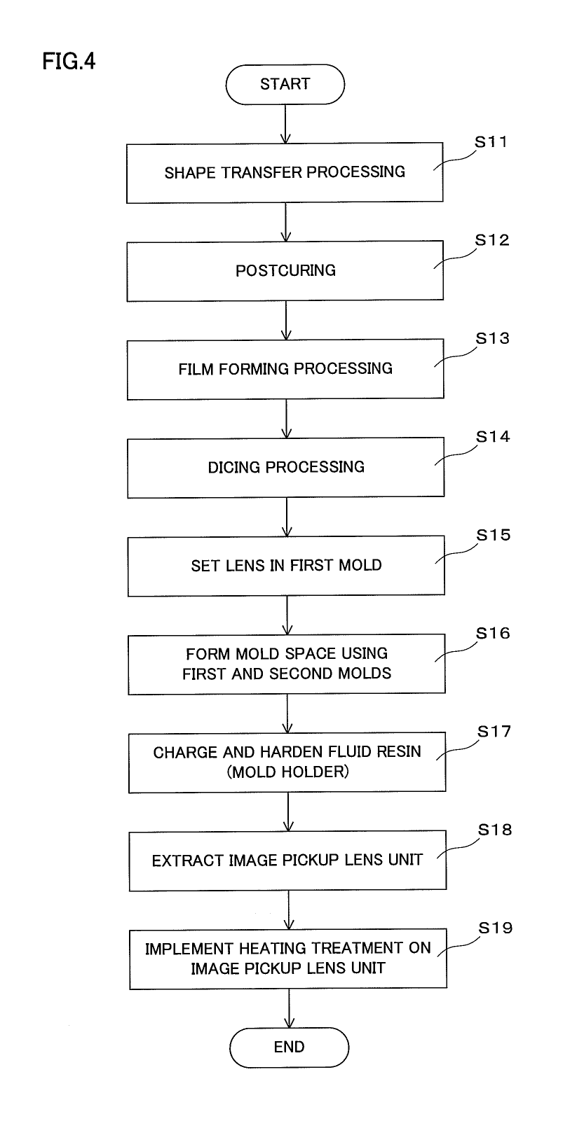

Next, referring to a flowchart in FIG. 4 and so on, a method of manufacturing the image pickup lens unit 100 and so on will be described.

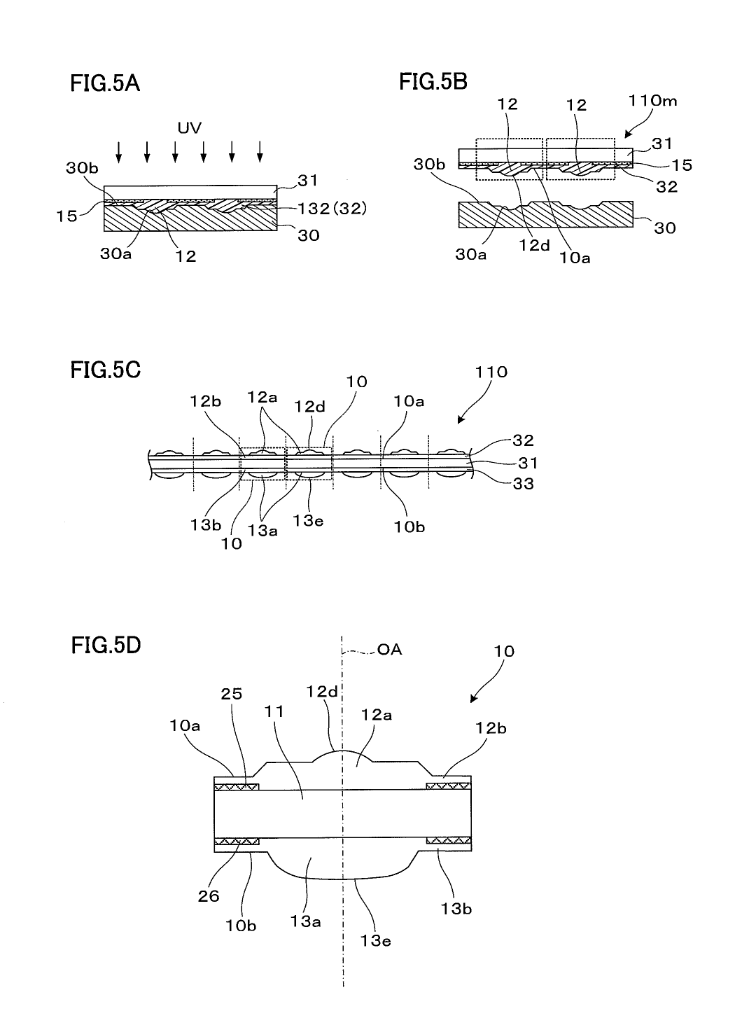

To manufacture the image pickup lens unit 100 shown in FIG. 1A and so on, first, a wafer lens 110 is molded in a shape transfer process shown in FIGS. 5A to 5C (step S11 in FIG. 4).

First, as shown in FIG. 5A, a resin material 132 is applied to a transfer mold 30, whereupon the transfer mold 30 is pressed against a front side surface of a glass substrate 31 via an appropriate interval. Next, the sandwiched resin material 132 is hardened by emitting ultraviolet rays from a UV generation apparatus, not shown in the drawings. As a result, transfer surfaces 30a and 30b of the transfer mold 30 are transferred onto the resin material 132, and as the resin material 132 hardens, a large number of first surfaces (the first optical surface 12d and the first frame surface 10a of the first lens layer 12, shown in FIG. 1A) are formed thereon. Thus, a first resin layer 32 including a large number of the first lens layers 12 is formed. Note that a metal film or a resin film is formed on (or adhered to) the front side surface of the glass substrate 31 in advance as the diaphragm 15.

Next, as shown in FIG. 5B, the first resin layer 32 and the glass substrate 31 are released from the transfer mold 30 integrally, whereby an intermediate body 110m that will serve as the wafer lens 110 is manufactured. Similar processing to the resin supply and mold surface transfer shown in FIG. 5A is performed on a surface of the intermediate body 110m on a rear side of the glass substrate 11, whereby the wafer lens 110 shown in FIG. 5C is manufactured. In other words, a second resin layer 33 of the wafer lens 110 is formed similarly to the first resin layer 32. The second resin layer 33 has a large number of second surfaces respectively including the second optical surface 13e and the second frame surface 10b of the second lens layer 13, shown in FIG. 1A.

Next, postcure processing is implemented (step S12 in FIG. 4) by performing heating treatment for approximately thirty minutes to one hour between 100 and 200° C. using a vacuum oven (not shown). In the postcure processing, a hardening reaction of the first resin layer 32 and the second resin layer 33 can be generated more completely so that when the first resin layer 32 and the second resin layer 33 are formed from an epoxy resin or the like, for example, a hardening time can be shortened.

Next, film forming processing (step S13 in FIG. 4) for forming an optical function film on a surface of the wafer lens 110 using a film forming apparatus (not shown) will be described. Here, an anti-reflection film, a protective film, or the like, for example, may be used as the optical function film. Depending on the specifications of the lens 10, the film forming process may be omitted.

The wafer lens 110 subjected to film forming processing using the method described above is then cut into individual elements by dicing (cutting), as shown by dot-dash lines L in FIG. 5C, whereby the lens 10 shown in FIG. 1A and so on is extracted (step S14 in FIG. 4).

Next, the holder member 40 for holding the lens 10 is molded on the periphery of the lens 10 (steps S15 to S18 in FIG. 4). More specifically, the holder member 40 that holds the lens 10 integrally in the interior thereof is formed by disposing the lens 10 in position inside a mold having a molding space for molding the holder member, charging resin into the molding space, and then hardening the resin. A method of molding a holder holding a lens integrally by disposing the lens in a mold having a molding space for molding the holder member and then filling the molding space with resin will be referred to in this specification as insert molding.

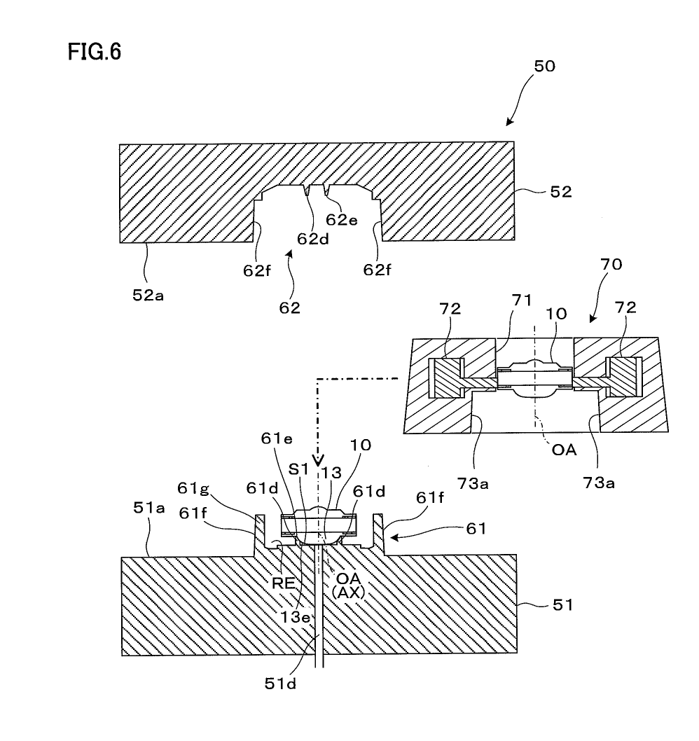

Next, referring to FIG. 6 and so on, molding of the holder member 40 using insert molding and manufacture of the image pickup lens unit 100 will be described specifically.

First, as shown in FIG. 6, a mold device 50 including a fixed side first mold 51 and a movable side second mold 52 is operated appropriately to open the two molds 51 and 52 such that the second mold 52 is set in a retracted condition, and to move an insert jig 70 holding the lens 10 to a position above a first molding portion 61 provided in the first mold 51. The first molding portion 61 serving as movement destination of the insert jig 70 is provided to project from a parting surface 51a of the first mold 51. A second molding portion 62 is provided opposite the first molding portion 61 on the second mold 52 side as an indentation from a parting surface 52a. A resin injection port, not shown in the drawing, is provided in at least one of the two molds 51 and 52. A heating mechanism for heating the molds 51 and 52, a platen for pressing the molds 51 and 52 from the rear, and so on are also provided, but these components have been omitted from the drawings to facilitate understanding.

The insert jig 70 is a ring-shaped member that holds the lens 10 temporarily in a central through hole 71. The insert jig 70 is driven remotely by a control driving apparatus, not shown in the drawing, to convey the lens 10. Further, a fluid-driven chuck member 72 having a plurality of pressing members that advance and retreat relative to the side faces 10c of the lens 10 is built into the insert jig 70. By pressing the side faces 10c of the lens 10 from a plurality of directions, the insert jig 70 can support the lens 10 in the center the through hole 71 in a set condition shown in the drawing, and make the lens 10 capable of moving through the through hole 71 in the optical axis OA direction in a released condition to be described below. A tapered ring-shaped fitting surface 73a for fitting the insert jig 70 to the first mold 51 is provided in a lower portion of the insert jig 70.

Next, the insert jig 70 is lowered onto the first mold 51 such that the fitting surface 73a on a lower portion inner side of the insert jig 70 is fitted to a fitting surface 61f of a tapered fitting member 61g that stands upright from the first molding portion 61. As a result, the optical axis OA of the lens 10 held by the insert jig 70 can be substantially aligned with an axis AX of the first molding portion 61 of the first mold 51. When, in this condition, the insert jig 70 is switched to the released condition, the lens 10 released from the grip of the chuck member 72 moves downward so as to be inserted into a recessed portion RE in the first molding portion 61 and held in the recessed portion RE in alignment therewith (step S15 in FIG. 4).

At this time, the lens 10 is supported on, and positioned in a lateral direction by, a cylindrical holding member 61d that stands upright from a bottom portion of the first molding portion 61. In other words, the holding member 61d serves as a positioning member for positioning the lens 10 precisely in a perpendicular direction to the optical axis OA. The holding member 61d also functions as a contact member that prevents resin from flowing onto the second optical surface 13e of the lens 10. To put it another way, the holding member 61d also serves to prevent fluid resin MP from flowing into a space S1 adjacent to the second optical surface 13e of the lens 10 during the molding to be described below.

Although not shown in detail in the drawings, the lens 10 is supported by the holding member 61d on an outer peripheral side of an upper surface of the holding member 61d. As a result, an outer side of the second optical surface 13e of the second lens layer 13, or more specifically an annular region of the second frame surface 10b close to a boundary with the second optical surface 13e, contacts an end surface 61e of the holding member 61d. Note, however, that the holding member 61d may support the lens 10 on an outermost edge (outside an effective region) of the second optical surface 13e.

An exhaust pipe 51d is formed in the first mold 51 to communicate with a center of a bottom surface of the first molding portion 61. The exhaust pipe 51d is made capable of discharging air to the outside at an appropriate timing by a driving mechanism annexed to the mold device 50. By decompressing the space S1 adjacent to the second optical surface 13e, the lens 10 placed on the holding member 61d can be suctioned to and positioned fixedly on the holding member 61d in alignment therewith by a desired suction force.

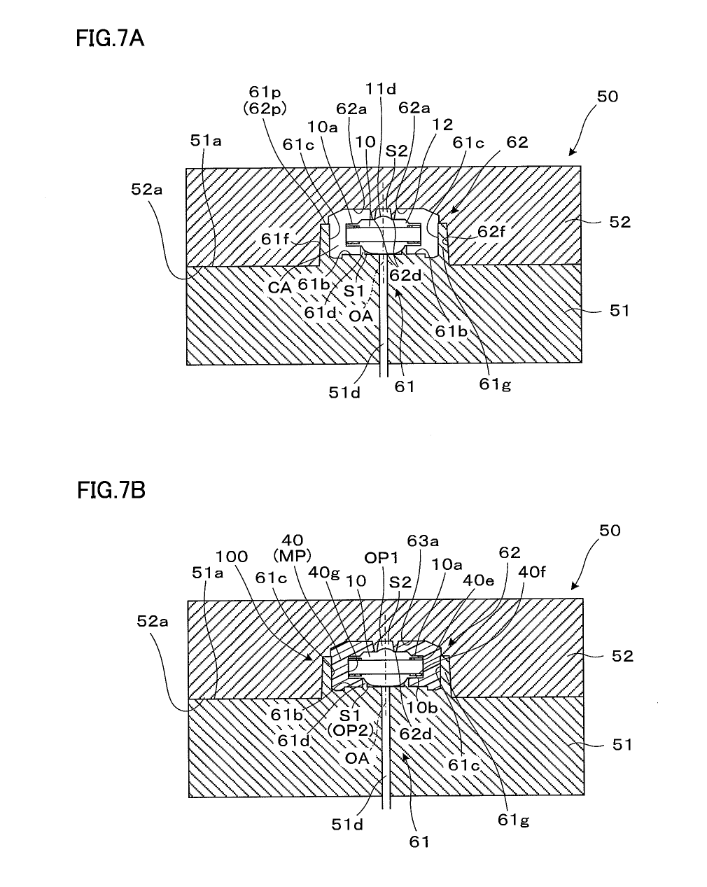

Next, as shown in FIG. 7A, the molds are clamped by moving the second mold 52, whereby a cavity (a mold space) CA for the holder member 40 is formed between the first mold 51 and the second mold 52 (step S16 of FIG. 4). At this time, the first molding portion 61 provided in the first mold 51 is fitted to the second molding portion 62 provided in the second mold 52. Here, transfer surfaces 61b and 61c for respectively molding a rear surface 40b and an outer peripheral side face 40c of the holder member 40 shown in FIG. 1 are formed on the first molding portion 61. Further, a transfer surface 62a for molding an upper surface 40a and so on of the holder member 40 is formed on the second molding portion 62 on the second mold 52 side. Furthermore, the cylindrical fixing member 62d that prevents the fluid resin MP from flowing into a space S2 adjacent to the first optical surface 12d of the lens 10 is formed in the second molding portion 62. The fixing member 62d contacts an innermost peripheral part of the frame portion 12b of the lens 10 when the molds are clamped so as to form the cavity CA serving as the molding space. As a result, the lens 10 is pressed gently downward, thereby stabilizing the lens 10 within the cavity CA and preventing the generation of play. The fixing member 62d also functions as a contact member that prevents resin from flowing onto the first optical surface 12d of the lens 10. To put it another way, the fixing member 62d also serves to prevent the fluid resin MP (see FIG. 7B) from flowing into the space S2 adjacent to the first optical surface 12d of the lens 10.

A slightly tapered fitting surface 62f is formed on an inner periphery of the second molding portion 62, and therefore, simply by fitting the second molding portion 62 to the first molding portion 61, the fitting surface 61f of the fitting member 61g of the first mold 51 is brought into close contact with the fitting surface 62f of the second mold 52 such that precise lateral direction alignment is achieved between the two molding portions 61 and 62. Further, when the two molding portions 61 and 62 are fitted together, an upper surface 61p of the fitting member 61g of the first molding portion 61 is disposed close to or in close contact with an outer peripheral bottom surface 62p of the second molding portion 62, and these surfaces 61p and 62p function as parting lines during molding of the holder member 40. As a result, the second molding portion 62 can be aligned precisely with the first molding portion 61, and therefore the lens 10.

Next, as shown in FIG. 7B, the fluid resin MP serving as the material of the holder member 40 is charged into the cavity CA serving as the molding space, whereby the first frame surface 10a, side faces 10c, and second frame surface 10b of the lens 10 are respectively covered in resin. The holder member 40 is then molded by hardening the fluid resin MP in the temperature-regulated mold (step S17 of FIG. 4). As a result, the image pickup lens unit 100 shown in FIG. 1A, in which the lens 10 is housed fixedly in the holder member 40 while being supported between the openings OP1 and OP2 of the holder member 40, is completed. At this time, the holding member 61d and the fixing member 62d provided respectively in the first and second molding portions 61 and 62 prevent the fluid resin MP from flowing into the spaces S1 and S2, and therefore serve to form the openings OP1 and OP2 in the holder member 40.

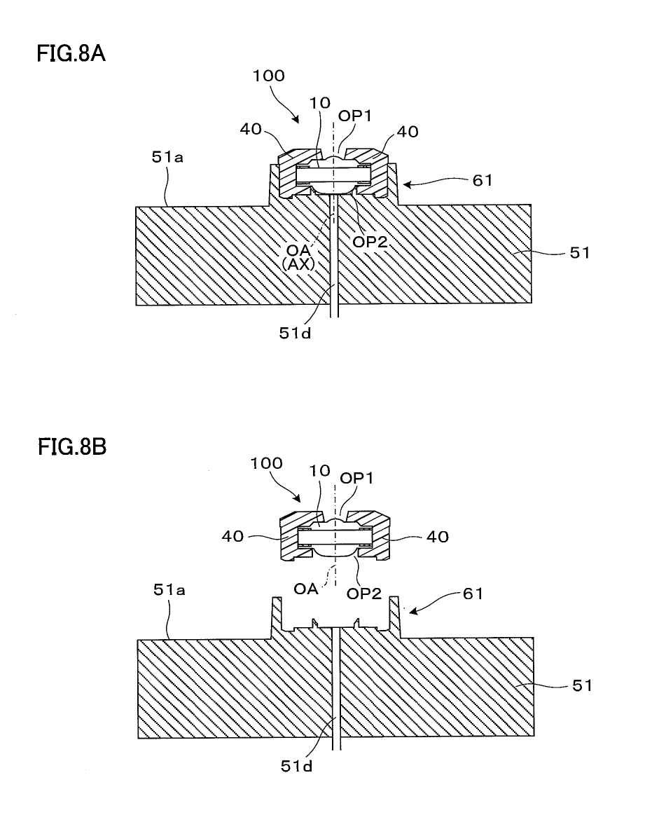

Next, as shown in FIG. 8A, the molds are opened by separating the second mold 52 from the first mold 51 such that the second mold 52 is set in the retracted condition. Next, as shown in FIG. 8B, an ejector pin or the like, not shown in the drawing, provided on the first mold 51 is used to push out the image pickup lens unit 100 so that the image pickup lens unit 100 is released from the mold. As a result, the image pickup lens unit 100 is extracted from the first mold 51 as an end product (step S18 in FIG. 4).

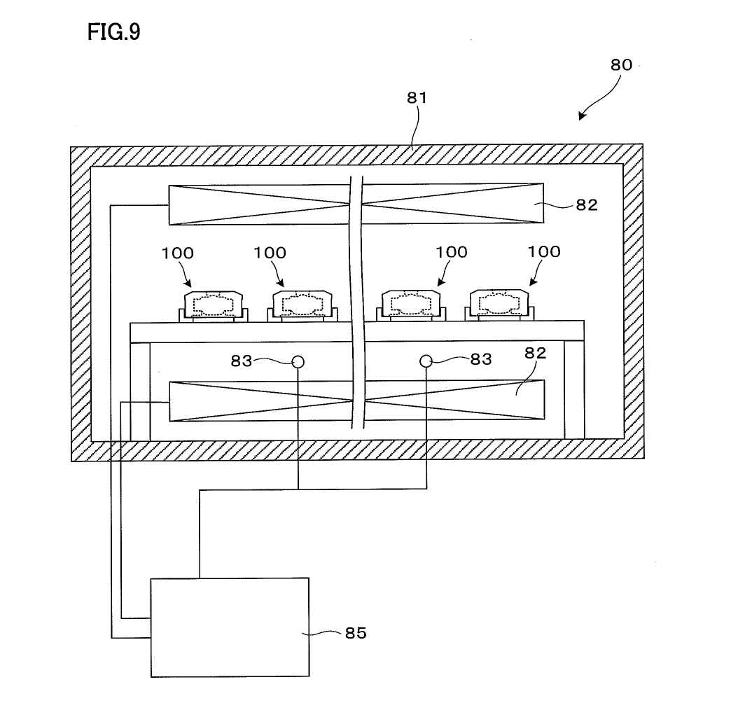

Next, heating treatment is performed on the image pickup lens unit 100 using a thermostat bath 80 shown in FIG. 9 in order to release distortion of the lens 10 (step S19 in FIG. 4). The thermostat bath 80 shown in the drawing is an oven including a processing chamber 81 having an adiabatic wall, a heater 82 for raising an internal temperature of the processing chamber 81, a temperature sensor 83 for measuring the internal temperature of the processing chamber 81, and a control apparatus 85 for controlling these components. Note that an atmosphere control apparatus for circulating an insert gas such as nitrogen may be annexed to the thermostat bath 80.

The image pickup lens unit 100 disposed in the processing chamber 81 of the thermostat bath 80 is subjected to heating treatment for a predetermined time at a target temperature by the heater 82 and the temperature sensor 83 under the control of the control apparatus 85. The heating treatment is performed by the thermostat bath 80 to release distortion of the lens 10 generated by the holding member 61d and the fixing member 62d of the molds 51 and 52 during molding of the holder member 40. A treatment temperature T applied to the image pickup lens unit 100 by the thermostat bath 80 is set within a range of Ta−20° C.≦T<Tb, where Ta is the deflection temperature under load of the resin material constituting the first and second lens layers 12 and 13 of the lens 10 and Tb is the heatproof temperature (the lower of the decomposition temperature and the melting point) of the resin material. When the upper limit of the use environment temperature is Tc, the treatment temperature T is preferably set within a range of Ta−20° C.≦T≦Tc, and more preferably set within a range of Ta≦T≦Tc. Note that Tc<Tb. The treatment time applied to the image pickup lens unit 100 by the thermostat bath 80 is set at an appropriate length that is at least long enough to release an amount of the distortion in the lens 10 required to satisfy the required optical performance thereof, and also in consideration of an amount by which the treatment temperature of the image pickup lens unit 100 is higher than Ta−20° C. or Ta, i.e. the lower limit value of the heating treatment. The treatment time of the image pickup lens unit 100 can be shortened by steadily increasing the treatment temperature above Ta−20° C. or Ta.

### (D. Specific Heating Treatment)

Specific heating treatment will be described below. First, the image pickup lens unit 100 having the configuration shown in FIG. 1 was manufactured as an image pickup lens unit to be subjected to the heating treatment by executing steps S11 to S18 of FIG. 4. Here, the first and second lens layers 12 and 13 constituting the lens 10 of the image pickup lens unit 100 were made of epoxy UV hardening resin. The deflection temperature under load (ISO75 A method) and the decomposition temperature of the resin constituting the respective lens layers 12 and 13 were 170° C. and about 320° C., respectively. Postcuring was performed on the first and second lens layers 12 and 13 for one hour at 200° C. Further, a thickness of the glass substrate 11 was set at 0.3 mm, a thickness of an upper surface resin layer (the first lens layer 12) in a part of the mold for molding holder (the first and second molds 51 and 52) corresponding to the lens contact portion (the holding member 61d and the fixing member 62d) was set at 0.12 mm, a thickness of a lower surface resin layer (the second lens layer 13) in the part of the mold for molding holder corresponding to the lens contact portion was set at 0.05 mm, and the lens 10 was formed with a square outer shape having a side length of 2.0 mm. Meanwhile, the holder member 40 of the image pickup lens unit 100 was made of LCP (Liquid Crystal Polymer) resin, and the resin constituting the holder member 40 had a deflection temperature under load (ISO75 A method) of 277° C. and a melting point of 320° C. Further, the lens contact portion of the used mold for molding holder had a ring-shaped upper surface side (the fixing member 62d) with an outer diameter of 1.26 mm and an inner diameter of 1.00 mm, and a ring-shaped lower surface side (the holding member 61d) with an outer diameter of 1.51 mm and an inner diameter of 1.10 mm, while one side of an outer side dimension of the holder member 40 was set at 3.2 mm.

A level difference, which is a depth or the like of the depression 12r or the impression 12s in the surface of the lens 10 before and after the heating treatment, was measured using a three-dimensional image shape measurement device. Further, an aspheric surface shape of the first and second optical surfaces 12d and 13e was measured by an ultra-high precision three-dimensional shape measurement device, using the more easily affected first optical surface 12d as a subject. An aspheric surface shape error was evaluated as being at a completely unproblematic level when an absolute value of a PV value (a Peak to Bottom Value, i.e. a difference between a maximum value and a minimum value) was smaller than 0.1 μm, at a level where surface variation exists but does not affect the performance in practice when the absolute value of the PV value was equal to or larger than 0.1 μm and smaller than 0.3 μm, and at a level that impedes practical use when the absolute value of the PV value was equal to or larger than 0.3 μm. It was found as a result that the first optical surface 12d of the lens 10 prior to formation of the holder member 40 did not include a shape error. In other words, a result of the measurement performed by the ultra-high precision three-dimensional shape measurement device showed that a difference in the actual shape relative to a design value had a PV value of 0 μm. The holder member 40 was then molded around the lens 10 by insert molding (steps S15 to S18 in FIG. 4). First, the level difference between the depression 12r serving as the contact portion that contacts the holding member 61d and the fixing member 62d of the molds 51 and 52 and the periphery thereof was measured using a three-dimensional image shape measurement device in relation to the image pickup lens unit 100 immediately after molding of the holder member 40. Further, the aspheric surface shape of the first optical surface 12d of the lens 10 was measured using an ultra-high precision three-dimensional shape measurement device. Next, heating treatment was implemented on the image pickup lens unit 100 using the thermostat bath 80 shown in FIG. 9, whereupon the level difference between the impression 12s of the depression 12r serving as the contact portion and the periphery thereof was measured again using a three-dimensional image shape measurement device. Moreover, the aspheric surface shape of the first optical surface 12d following the heating treatment implemented on the lens 10 was measured using an ultra-high precision three-dimensional shape measurement device. The level difference between the depression 12r of the lens 10 and the periphery thereof prior to the heating treatment was approximately 20 μm, and the aspheric surface shape error of the first optical surface 12d had a PV value of approximately 1 μm, i.e. at the level that impedes practical use.

In a sample that was subjected to the heating treatment in the thermostat bath 80 for one minute at a heating temperature of 250° C., the level difference between the impression 12s in the contact portion and the periphery thereof was 0 μm, and the aspheric surface shape error was also 0 μm, i.e. at the completely unproblematic level. In other words, by annealing the lens 10 and so on, it was possible to manufacture the image pickup lens unit 100 with favorable first and second optical surfaces 12d and 13e.

In a sample that was subjected to the heating treatment in the thermostat bath 80 for one minute at a heating temperature of 200° C., the level difference between the impression 12s in the contact portion and the periphery thereof was 3 μm, and the aspheric surface shape error was at the level that does not affect practical use. In other words, by annealing the lens 10 and so on, it was possible to manufacture the image pickup lens unit 100 with favorable first and second optical surfaces 12d and 13e, although the impression 12s remained to a small degree.

In both a sample that was subjected to the heating treatment in the thermostat bath 80 for one hour at a heating temperature of 200° C. and a sample that was subjected to the heating treatment for one hour at a heating temperature of 250° C., the level difference between the impression 12s in the contact portion and the periphery thereof was 0 μm and the aspheric surface shape error was also 0 μm, i.e. at the completely unproblematic level. In other words, by annealing the lens 10 and so on, it was possible to manufacture the image pickup lens unit 100 with favorable first and second optical surfaces 12d and 13e.

In a sample that was subjected to the heating treatment in the thermostat bath 80 for one hour at a heating temperature of 150° C., the level difference between the impression 12s in the contact portion and the periphery thereof was 5 μm, and the aspheric surface shape error was at the level that does not affect practical use. In other words, by annealing the lens 10 and so on, it was possible to manufacture the image pickup lens unit 100 with favorable first and second optical surfaces 12d and 13e, although the impression 12s remained to a small degree.

In a sample that was subjected to the heating treatment in the thermostat bath 80 for twenty-four hours at a heating temperature of 200° C., the level difference between the impression 12s in the contact portion and the periphery thereof was 0 μm, and the aspheric surface shape error was also 0 μm. In other words, by annealing the lens 10 and so on, it was possible to manufacture the image pickup lens unit 100 with favorable first and second optical surfaces 12d and 13e.

In a sample that was subjected to the heating treatment in the thermostat bath 80 for twenty-four hours at a heating temperature of 150° C., the level difference between the impression 12s in the contact portion and the periphery thereof was 3 μm, and the aspheric surface shape error was at the level that does not affect practical use. In other words, by annealing the lens 10 and so on, it was possible to manufacture the image pickup lens unit 100 with the first and second optical surfaces 12d and 13e at a favorable level. Moreover, the impression 12s, although remaining slightly, was not large enough to affect practical use.

With the manufacturing method for the image pickup lens unit 100 and so on according to the first embodiment described above, the resin holder member 40 that holds the lens 10 in position in the interior thereof can be formed. At this time, the surfaces of the first and second lens layers 12 and 13 of the lens 10 may be deformed by the molds 51 and 52 such that the depression 12r or the like remains in the first and second lens layers 12 and 13 as distortion that affects the first and second optical surfaces 12d and 13e of the first and second lens layers 12 and 13. By subjecting the lens 10 and the holder member 40 to the heating treatment described above, however, this distortion can be released, and as a result, an original optical precision of the first and second optical surfaces 12d and 13e of the lens 10 can be restored. In other words, the lens 10 can be returned to its original condition after deforming during molding of the holder member 40, making it possible to provide an image pickup lens unit 100 in which deformation of the lens 10 occurring during molding of the holder member 40 is suppressed.

### Second Embodiment

A structure of an image pickup lens unit and a manufacturing method thereof according to a second embodiment will be described below. Note that the manufacturing method for an image pickup lens unit and so on according to the second embodiment differs only partially from the first embodiment, and therefore matter not described specifically is assumed to be identical to the first embodiment.

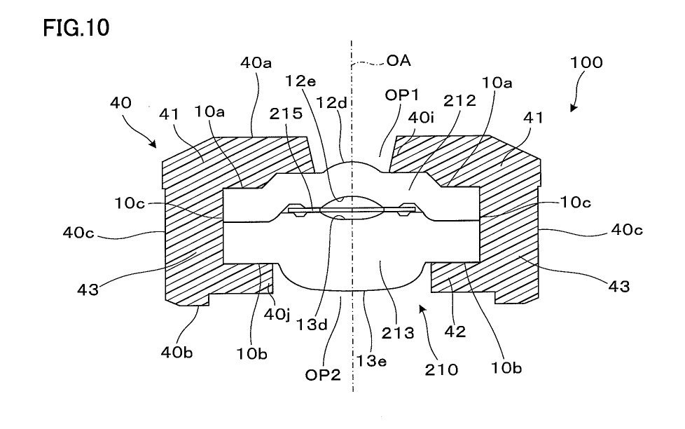

As shown in FIG. 10, a lens 210 incorporated into the holder member 40 is a combination lens including a first lens element 212, a second lens element 213, and a diaphragm 215 sandwiched between the first and second lens elements 212 and 213.

The first lens element 212 has a pair of optical surfaces 12d and 12e, and is formed from a hardening resin possessing reflow heat resistance, for example. The second lens element 213 has a pair of optical surfaces 13d and 13e, and is formed from a hardening resin possessing reflow heat resistance, for example.

Likewise in the second embodiment which, in contrast to the first embodiment, uses the lens 210 not including the glass substrate 11, distortion generated in the lens elements 212 and 213 during molding of the holder member 40 can be released by implementing heating treatment on the lens 210 and the holder member 40, and as a result, the original optical precision of the optical surfaces 12d and 13e of the lens 210 can be restored.

### Third Embodiment

A structure of an image pickup lens unit and a manufacturing method thereof according to a third embodiment will be described below. Note that the manufacturing method for an image pickup lens unit and so on according to the third embodiment differs only partially from the first embodiment, and therefore matter not described specifically is assumed to be identical to the first embodiment.

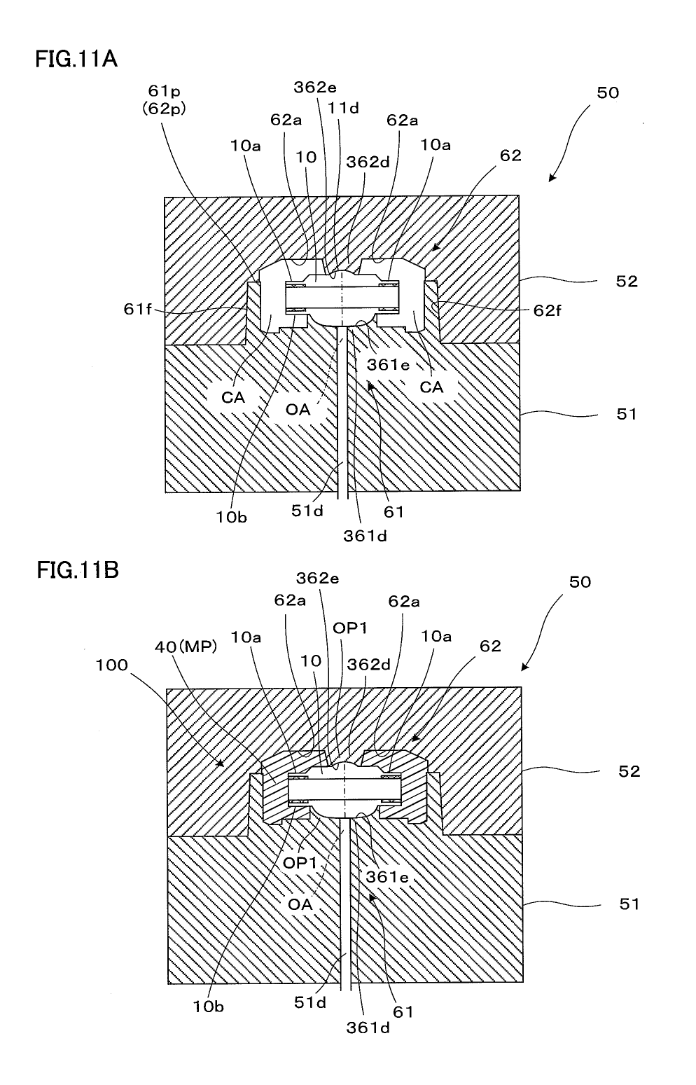

As shown in FIG. 11A, in the first mold 51, a holding member 361d provided in a rear of the first molding portion 61 is a columnar projection, and an end surface 361e serving as a contact surface has an identical or substantially identical curvature to the second optical surface 13e of the lens 10 so as to be capable of surface contact with the second optical surface 13e (see FIG. 1A) of the lens 10. Hence, the end surface 361e of the holding member 361d and the second optical surface 13e of the lens 10 contact each other closely in surface contact, thereby preventing the fluid resin MP from leaking onto the second optical surface 13e at a molding stage shown in FIG. 11B, and as a result, the opening OP2 can be formed in the holder member 40.

Similarly, in the second mold 52, a fixing member 362d provided in a rear of the second molding portion 62 is a columnar projection, and an end surface 362e serving as a contact surface has an identical or substantially identical curvature to the first optical surface 12d of the lens 10 so as to be capable of surface contact with the first optical surface 12d (see FIG. 1A) of the lens 10. Hence, the end surface 362e of the fixing member 362d and the first optical surface 12d of the lens 10 contact each other closely in surface contact, thereby preventing the fluid resin MP from leaking onto the first optical surface 12d, and as a result, the opening OP1 can be formed in the holder member 40.

Hence, likewise according to the third embodiment, in which the fixing member of the mold contacts the entire optical surface of the lens 10, distortion generated in the lens 10 during molding of the holder member 40 can be released by implementing heating treatment on the lens 10 and the holder member 40, and as a result, the original optical precision of the first and second optical surfaces 12d and 13e of the lens 10 can be restored.

### Fourth Embodiment

A structure of an image pickup lens unit and a manufacturing method thereof according to a fourth embodiment will be described below. Note that the manufacturing method for an image pickup lens unit and so on according to the fourth embodiment differs only partially from the first embodiment, and therefore matter not described specifically is assumed to be identical to the first embodiment.

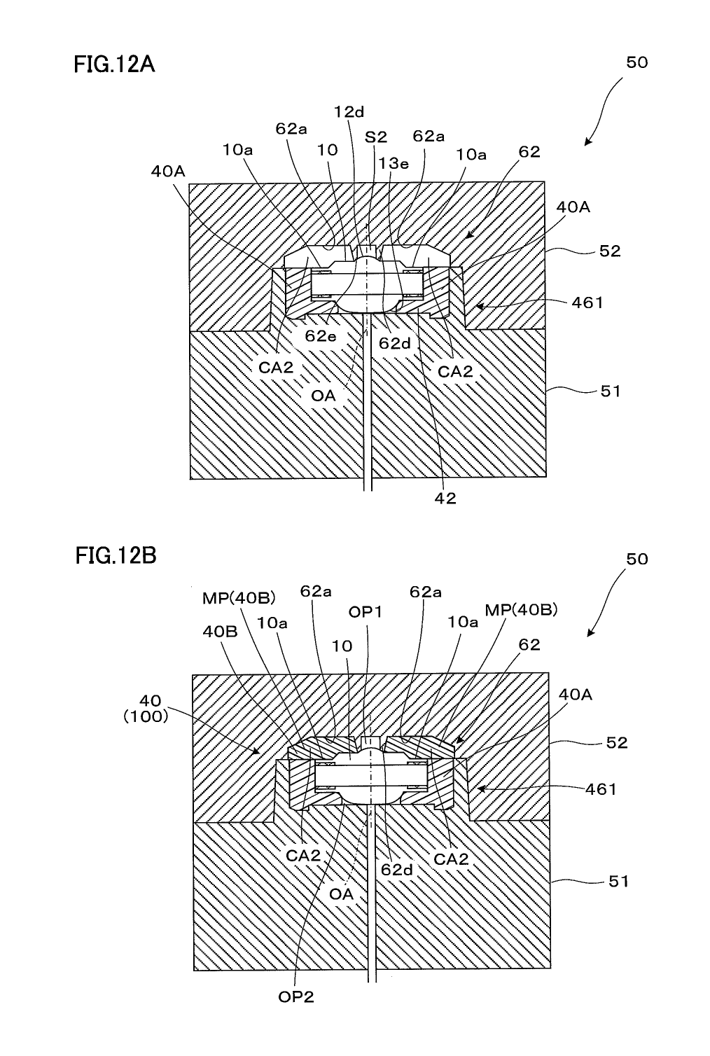

As shown in FIG. 12A, a first holder part 40A is formed in a first molding portion 461 of the first mold 51 so as to be fitted into a recessed portion of the first molding portion 461 by performing injection molding using a molding portion not shown in the drawing. In this embodiment, although not shown in detail in the drawing, a slight gap is formed between the lens 10 and an inner surface (an inner wall) of a side wall of the first holder part 40A. Further, the lens 10 is supported by the bottom portion 42 of the first holder part 40A and positioned in the lateral direction such that an optical surface thereof is aligned with the center of the holder opening portion. Note that the insert jig 70 shown in FIG. 6 is used to set the lens 10 in the first holder part 40A embedded in the first molding portion 61.

The transfer surface 62a for molding the upper portion of the holder member 40 is formed on the second molding portion 62 on the second mold 52 side. Further, the cylindrical fixing member 62d that prevents the fluid resin MP from flowing into the space S2 adjacent to the first optical surface 12d of the lens 10 is formed in the second molding portion 62.

As shown in FIG. 12B, the fluid resin MP serving as the material of the holder member 40 is charged into a cavity CA2 serving as the molding space so that the first frame surface 10a of the lens 10 is covered in resin. A second holder part 40B is then molded by hardening the fluid resin MP in the temperature-regulated mold. As a result, the first holder part 40A and the second holder part 40B are welded to each other, whereby the holder member 40 can be formed as a whole. In other words, the image pickup lens unit 100 in which the lens 10 is housed fixedly in the holder member 40 is completed.

In the fourth embodiment, the first optical surface 12d may be affected by heat from the resin during molding of the second holder part 40B so as to deform in the location of the fixing member 62d provided in the second molding portion 62, and as a result, the optical performance may deteriorate. However, by implementing heating treatment on the lens 10 and the holder member 40 after molding the first holder part 40A and the second holder part 40B, the distortion generated in the lens 10 during molding of the holder member 40 can be released, whereby the original optical precision of the first optical surface 12d and so on of the lens 10 can be restored. Note that in this embodiment, the first holder part 40A serving as a resin body constituting a part of the holder is disposed in the mold before disposing the lens 10 in the molding space, and therefore the part of the holder to be molded after disposing the lens in the mold is smaller than those of the above embodiments. As a result, the distortion generated in the lens 10 can be reduced. Further, the second optical surface 13e contacts the resin first holder part 40A, and is not therefore affected by the heat generated during molding of the second holder part 40B. Hence, the second optical surface 13e does not deform in the manner of the first optical surface 12d during molding of the second holder part 40B, and therefore the optical performance thereof is maintained. Moreover, since deformation does not occur, the optical performance is likewise maintained after the heating treatment.

The present invention was described above using embodiments, but the present invention is not limited to the above embodiments. More specifically, in the above embodiments, the shapes and structures of the lens 10 and 210 are merely examples, and may be modified appropriately. For example, the lens 10 does not have to be prism-shaped, and may be columnar or the like.

Further, in the above embodiments, only the lens 10 is held in the holder member 40, but an additional component such as an IR cut filter or a height adjustment plate may also be held. In this case, the distortion generated in the lens 10 during molding of the holder member 40 can be released so as to return or restore the lens 10 to its original condition by implementing the heating treatment on the image pickup lens unit 100 including the additional component.

Furthermore, in the above embodiments, the mold device is a vertical mold device in which the second mold 52 is moved in a vertical direction, but may be a horizontal mold device in which the movable mold moves in a left-right direction. In this case, the lens 10 and so on must be suctioned and held by at least one of the molds to prevent the lens 10 and so on from falling.

Furthermore, in the above embodiments, thermoplastic resin is used as the resin material of the holder member, but the present invention is not limited thereto, and a hardening resin such as thermosetting resin may be used instead.

Moreover, a plurality of molding portions may be provided in the mold so that holders are molded simultaneously in relation to a plurality of lenses. In this case, it is not necessary to provide an alignment member in each molding portion, and a common alignment member may be used for the plurality of molding portions.

1. A manufacturing method for an image pickup lens unit, comprising the steps of:
forming a holder member that holds a lens at least partially including resin, integrally in an interior thereof by disposing the lens in position in a mold having a molding space for molding at least a part of the holder member, and then charging resin into the molding space and hardening the resin; and
releasing distortion occurring in the lens during formation of the holder member by implementing heating treatment on the lens held by the holder member.

2. The manufacturing method for an image pickup lens unit according to claim 1, wherein the lens is a compound lens including a substrate and a lens layer, and the lens layer is made of resin.

3. The manufacturing method for an image pickup lens unit according to claim 1, wherein the lens is a combination lens including a plurality of integrated lens elements, and at least one of the plurality of lens elements is made of resin.

4. The manufacturing method for an image pickup lens unit according to claim 1, wherein the lens is formed using an energy hardening resin.

5. The manufacturing method for an image pickup lens unit according to claim 1, wherein the lens is formed using a thermoplastic resin.

6. The manufacturing method for an image pickup lens unit according to claim 1, wherein the holder member is formed from at least one of LCP resin and PPA resin.

7. The manufacturing method for an image pickup lens unit according to claim 1, wherein the mold includes at least one contact member that prevents the resin from flowing onto at least one optical surface provided in a surface of the lens.

8. The manufacturing method for an image pickup lens unit according to claim 7, wherein the at least one contact member contacts an outer side of the optical surface while avoiding the optical surface.

9. The manufacturing method for an image pickup lens unit according to claim 7, wherein the at least one contact member has a substantially identical shape to the optical surface and contacts the optical surface.

10. The manufacturing method for an image pickup lens unit according to claim 1, wherein the heating treatment is performed in a temperature range equal to or higher than a lower limit temperature that is 20° C. lower than a deflection temperature under load of a resin part of the lens and lower than an upper limit temperature corresponding to a decomposition temperature or a melting point of the resin part of the lens.

11. The manufacturing method for an image pickup lens unit according to claim 10, wherein the heating treatment is performed in a temperature range equal to or lower than 260° C., which is an upper limit of a use environment temperature of the lens.

12. The manufacturing method for an image pickup lens unit according to claim 1, wherein a deflection temperature under load of the holder member is higher than a deflection temperature under load of a resin part of the lens.

13. The manufacturing method for an image pickup lens unit according to claim 1, wherein the holder member is formed by disposing a resin body constituting a part of the holder in the mold before disposing the lens in the mold, charging the resin into the mold, and hardening the resin such that the hardened resin is joined to the resin body.

14. An image pickup lens unit comprising:
a lens having a first optical surface and a second optical surface; and
a holder member that is formed by supplying resin to a periphery of the lens while the lens is disposed in a mold and then hardening the resin such that the lens is held integrally in an interior of the holder member,
wherein the lens is subjected to heating treatment while being held by the holder member.

15. The image pickup lens unit according to claim 14, wherein the lens includes a contact impression formed by a contact member that is provided in the mold to prevent the resin from flowing onto at least one of the first optical surface and the second optical surface.
